(19) United States
(12) Patent Application Publication
(10) Pub. No.: US 2013/0163068 A1
(43) Pub. Date: Jun. 27, 2013

(54) DISPLAY ELEMENT AND ELECTRICAL APPARATUS USING SAME

(71) Applicants: Toshiki Matsuoka, Osaka (JP); Tomoko Teranishi, Osaka (JP); Shun Ueki, Osaka (JP); Takuma Tomotoshi, Osaka (JP)

(72) Inventors: Toshiki Matsuoka, Osaka (JP); Tomoko Teranishi, Osaka (JP); Shun Ueki, Osaka (JP); Takuma Tomotoshi, Osaka (JP)

(73) Assignee: SHARP KABUSHIKI KAISHA, Osaka-shi ,Osaka (JP)

(21) Appl. No.: 13/819,647

(22) PCT Filed: May 10, 2011
(86) PCT No.: PCT/JP2011/060737

§ 371 Date: Feb. 27, 2013

(30) Foreign Application Priority Data
Aug. 27, 2010 (JP) 2010-190384

(51) Int. Cl. G02B 26/00

(52) U.S. Cl. CPC G02B 26/005; G02B 26/08
USPC 359/296

(57) ABSTRACT

A display element (10) includes an upper substrate (first substrate) (2), a lower substrate (second substrate) (3), a polar liquid (16) that is movably sealed on an effective display region (P1) side or a non-effective display region (P2) side inside a display space (S), a rib (14) that is provided on the lower substrate (3) so as to hermetically compartment the inside of the display space (S) according to each of a plurality of pixel regions (P), and oil (insulating fluid) (17) that is movably sealed inside the display space (S) for each pixel region (P) and does not mix with the polar liquid (16). In addition, when the polar liquid (16) is moved inside the display space (S) for each pixel region (P), signal electrodes (4) are provided on the lower substrate (3) side so that the flow path of the oil (17) inside the display space (S) becomes large.

### TECHNICAL FIELD

The present invention relates to a display element that displays information such as images and characters by causing a polar liquid to move, and an electrical apparatus using the display element.

### BACKGROUND ART

In recent years, as typified by an electrowetting type display element, a display element that displays information using a polar liquid movement phenomenon caused by an external electric field has been developed, and put into practical use.

To describe in detail, as described in Patent Document 1 described below, for example, a display space is formed between a first and a second substrates, and the inside of each display space is compartmented according to each of a plurality of pixel regions using a rib (partition wall) in such a display element of the related art. In addition, in the display element of the related art, in each of the pixel regions described above, a conductive liquid (polar liquid) is sealed, and a signal electrode, and a scanning electrode and a standard electrode (reference electrode) which are provided in parallel to each other are provided so that the signal electrode intersects with the scanning and the standard electrodes. Further, the display element of the related art is designed such that the conductive liquid is moved on the scanning electrode side or the standard electrode side in each pixel region by appropriately applying a voltage to the signal electrode, the scanning electrode, and the standard electrode, and thereby changing a display color on a display surface.
[Patent Document 1] Pamphlet of International Publication WO2008/155926

### DISCLOSURE OF INVENTION

### Problems to be Solved by the Invention

However, in the display element of the related art described above, setting the display color on the display surface side to be halftone, that is, grayscale display is performed in such a way that the movement amount of the conductive liquid (polar liquid) is changed by adjusting the magnitude of the voltage applied to the signal electrode.

However, in the display element of the related art as described above, there is concern that it is difficult to change the display color with high accuracy. Particularly, in the display element of the related art, when the above-described grayscale display is performed, the conductive liquid is difficult to be precisely moved in a desired position, a subtle color difference is made, and accordingly, there is concern of causing degradation of display quality.

To describe in more detail, in the display element of the related art, in order to improve a movement speed of the conductive liquid inside the pixel regions, the pixel regions are not completely sealed by the rib, and apertures that enable the insides of adjacent pixel regions to communicate with each other are provided in four corners of the pixel regions that is formed in, for example, a rectangular shape. Furthermore, in the display element of the related art, in order to improve a movement speed of the conductive liquid, oil (insulating fluid) that will not mix with the conductive liquid is sealed inside the pixel regions so as to be movable. For these reasons, in the display element of the related art, the conductive liquid is sometimes finely moved by the oil flowing from an adjacent pixel region due to the magnitude of the apertures, the base materials of the conductive liquid and the oil, the movement speed of the conductive liquid, or the like.

In addition, in the display element of the related art, when the conductive liquid is finely moved as described above, if a next display operation is performed, there are cases in which the conductive liquid is not moved precisely at a position at which the liquid is supposed to be moved in the display operation even if a voltage according to the display operation is correctly applied to the signal electrode. As a result, a subtle color difference is made and accordingly, there is concern that degradation of display quality occurs in the display element of the related art.

The present invention considered the above problems and aims to provide a display element and an electrical apparatus using the display element that can prevent degradation of display quality even when grayscale display is performed.

### Means for Solving the Problems

In order to achieve the object, a display element according to the present invention includes a first substrate provided on a display surface side, a second substrate provided on a non-display surface side of the first substrate so as to form a predetermined display space between the first substrate, an effective display region and a non-effective display region set for the display space, a polar liquid that is movably sealed on the effective display region side or the non-effective display region side inside the display space and to be able to change a display color on the display surface side by causing the polar liquid to move, a plurality of signal electrodes that is disposed inside the display space and provided along a predetermined arrangement direction so as to come into contact with the polar liquid, a plurality of reference electrodes that is provided on either side of the first substrate or the second substrate so as to be disposed on one side of the effective display region and the non-effective display region while being electrically insulated from the polar liquid and so as to intersect with the plurality of signal electrodes, a plurality of scanning electrodes that is provided on either side of the first substrate or the second substrate so as to be disposed on the other side of the effective display region and the non-effective display region while being electrically insulated from the polar liquid and the reference electrodes and so as to intersect with the plurality of signal electrodes, a plurality of pixel regions that are provided in a unit of intersection portions of the signal electrodes and the scanning electrodes, a rib that is provided on at least the either side of the first substrate or the second substrate so as to hermetically compartment the inside of the display space according to each of the plurality of pixel regions, and an insulating fluid that is movably sealed inside the display space for each of the pixel regions and does not mix with the polar liquid, and when the polar liquid is moved inside the display space for each of the pixel regions, the signal electrodes are provided on either side of the first substrate or the second substrate so that the flow path of the insulating fluid inside the display space becomes large.

In the display element configured as described above, the inside of the display space is hermetically compartmented by the rib according to each of the plurality of pixel regions. Accordingly, the insulating fluid can be prevented from flowing in from an adjacent pixel region, and an occurrence of a fine movement of the polar liquid caused by the insulating fluid from the adjacent pixel region can be prevented, unlike the related art. In addition, when the polar liquid is moved inside the display space for each pixel region, the signal electrodes are provided on either side of the first substrate or the second substrate so that the flow path of the insulating fluid inside the display space becomes large. In other words, wettability (contact angle) of the polar liquid resulting from the electrowetting phenomenon that occurs during a movement of the polar liquid does not change on portions in which the signal electrodes are provided on either side of the first substrate or the second substrate on which the reference electrodes and the scanning electrodes are provided. For this reason, peripheral portions of the signal electrodes can be secured as the flow path of the insulating fluid not as the flow path of the polar liquid, and accordingly the flow path of the insulating fluid can be increased. As a result, even when the polar liquid is moved to change a display color, the polar liquid can be smoothly and appropriately moved. Thus, unlike the related art, the display element that can prevent degradation of display quality even when grayscale display is performed can be configured.

In addition, in the display element, the signal electrodes may be linearly provided along a direction parallel with a movement direction of the polar liquid.

In this case, the large flow path of the insulating fluid can be secured along the direction parallel with the movement direction of the polar liquid, and accordingly, the polar liquid can be smoothly ad appropriately moved.

In addition, in the display element, the rib may include first rib members that are provided along the direction vertical to the movement direction of the polar liquid and second rib members that are provided along the direction parallel with the movement direction of the polar liquid, and, when the size of separation between the first and the second substrates is set to H, and when the size of interval between two second rib members compartmenting each of the pixel regions to W, and the distance between one of the second rib member and the center line of each of the signal electrodes in the direction vertical to the movement direction of the polar liquid to x, it is preferable that the signal electrodes be provided so as to satisfy the following inequality (1), which is:

H/2<x<W/4 (1).

In this case, being a non-contact state of the signal electrodes and the polar liquid can be reliably prevented, and the flow path of the insulating fluid can be assuredly increased.

In addition, in the display element, the signal electrodes may be provided so as to form a predetermined angle with a movement direction of the polar liquid.

In this case, being a non-contact state of the signal electrodes and the polar liquid can be reliably prevented, and the large flow path of the insulating fluid can be secured.

In addition, in the display element, it is preferable that the signal electrodes be provided so that one end portions and the other end portions thereof are on the one end portion sides and the other end portion sides in respective pixel regions in a direction vertical to a movement direction of the polar liquid.

In this case, being a non-contact state of the signal electrodes and the polar liquid can be reliably prevented, and the large flow path of the insulating fluid can be secured.

In addition, it is preferable that the display element include a signal voltage application unit that is connected to the plurality of signal electrodes and applies a signal voltage within a predetermined voltage range to each of the plurality of signal electrodes according to information displayed on the display surface, a reference voltage application unit that is connected to the plurality of reference electrodes and applies either voltage of a selection voltage that allows the polar liquid to move inside the display space according to the signal voltage or a non-selection voltage that hinders the polar liquid from moving inside the display space to each of the plurality of reference electrodes, and a scanning voltage application unit that is connected to the plurality of scanning electrodes and applies either voltage of a selection voltage that allows the polar liquid to move inside the display space according to the signal voltage or a non-selection voltage that hinders the polar liquid to move inside the display space to each of the plurality of scanning electrodes.

In this case, a matrix drive type display element exhibiting excellent display quality can be easily configured, and display colors in each pixel region can be appropriately changed.

In addition, in the display element, the plurality of pixel regions may be respectively provided according to a plurality of colors that can perform full-color display on the display surface.

In this case, color image display can be performed by appropriately moving the polar liquid corresponding to each of the plurality of pixel regions.

In addition, in the display element, it is preferable that a dielectric layer be laminated on surfaces of the reference electrodes and the scanning electrodes.

In this case, the movement speed of the polar liquid can be easily enhanced by assuredly increasing an electric field applied to the polar liquid by the dielectric layer.

In addition, in the display element, it is preferable that the non-effective display region be set by a light-shielding film provided on either side of the first substrate or the second substrate, and the effective display region be set by apertures formed on the light-shielding film.

In this case, the effective display region and the non-effective display region can be appropriately and assuredly set for the display space.

In addition, an electrical apparatus of the present invention is an electrical apparatus that includes a display unit that displays information including characters and images thereon, and, any display element described above is used for the display unit.

In the electrical apparatus configured as described above, the display element that can prevent degradation of display quality even when a grayscale display is performed is used for the display unit, a high-performance electrical apparatus having a display unit exhibiting excellent display quality can be easily configured.

### Advantages

According to the present invention, a display element that can prevent degradation of display quality even when grayscale display is performed and an electrical apparatus using the display element can be provided.

### BRIEF DESCRIPTION OF DRAWINGS

FIG. 1 is a plan view describing a display element and an image display device according to a first embodiment of the present invention.

FIG. 2 is an enlarged plan view showing a configuration of main portions thereof on an upper substrate side shown in FIG. 1 as viewed from a display surface side.

FIG. 3 is an enlarged plan view showing a configuration of main portions thereof on a lower substrate side shown in FIG. 1 as viewed from a non-display surface side.

FIGS. 4(a) and 4(b) are cross-sectional diagrams respectively showing a configuration of main portions of the display element shown in FIG. 1 during non-CF coloring display and CF coloring display.

FIG. 5(a) is an enlarged plan view showing a configuration of main portions of the display element in one pixel region, and FIGS. 5(b) and 5(c) are diagrams describing an operation of a polar liquid and oil shown in FIG. 5(a).

FIG. 6 is a diagram describing an operation example of the image display device.

FIG. 7 is an enlarged plan view showing a configuration of main portions of a display element according to a second embodiment of the present invention on a lower substrate side as viewed from a non-display surface side.

FIG. 8(a) is an enlarged plan view showing a configuration of main portions of the display element shown in FIG. 7 in one pixel region, and FIGS. 8(b) and 8(c) are diagrams describing an operation of a polar liquid and oil shown in FIG. 8(a).

FIG. 9 is an enlarged plan view showing a configuration of main portions of a display element according to a third embodiment of the present invention on a lower substrate side as viewed from a non-display surface side.

FIG. 10(a) is an enlarged plan view showing a configuration of main portions of the display element shown in FIG. 9 in one pixel region, and FIGS. 10(b) and 10(c) are diagrams describing an operation of the polar liquid and oil shown in FIG. 10(a).

FIG. 11 is an enlarged plan view showing a configuration of main portions of a display element according to a fourth embodiment of the present invention on a lower substrate side as viewed from a non-display surface side.

FIG. 12(a) is an enlarged plan view showing a configuration of main portions of the display element shown in FIG. 11 in one pixel region, and FIGS. 12(b) and 12(c) are diagrams describing an operation of the polar liquid and oil shown in FIG. 12(a).

### BEST MODES FOR CARRYING OUT THE INVENTION

Hereinafter, preferred embodiments of a display element and an electrical apparatus of the present invention will be described with reference to drawings. Note that, in the description below, a case in which the present invention is applied to an image display device that includes a display unit that can perform color image display thereon will be exemplified. In addition, the dimensions of each constituent element in the drawings do not fully indicate the dimensions of actual constituent elements and the dimension ratios of the respective constituent elements.

### First Embodiment

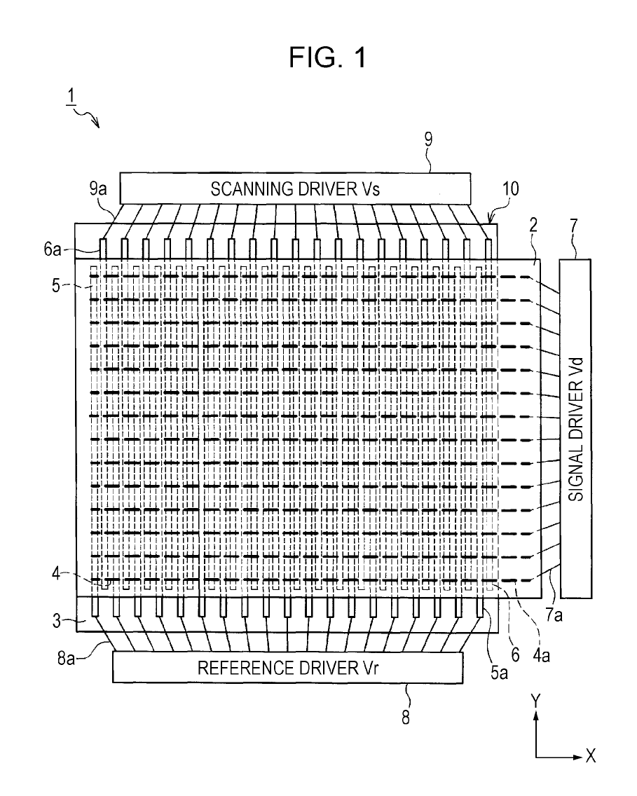

FIG. 1 is a plan view describing a display element and an image display device according to a first embodiment of the present invention. In FIG. 1, in the image display device 1 of the present embodiment, a display unit using the display element 10 of the present invention is provided, and the display unit includes a rectangular display surface. In other words, the display element 10 includes an upper substrate 2 and a lower substrate 3 which are disposed so as to overlap each other in the direction vertical to the surface of the paper of FIG. 1, and an effective display region of the display surface is formed in the overlapping portion of the upper substrate 2 and the lower substrate 3 (details thereof will be described later).

In addition, in the display element 10, a plurality of signal electrodes 4 are provided in stripe shapes at a predetermined interval along the X direction. In addition, in the display element 10, a plurality of reference electrodes 5 and a plurality of scanning electrodes 6 are provided in stripe shapes so as to intersect with each other along the Y direction. The plurality of signal electrodes 4, and the plurality of reference electrodes 5 and scanning electrodes 6 are provided so as to intersect with each other, and in the display element 10, a plurality of pixel regions are set in a unit of intersecting portions of the signal electrodes 4 and the scanning electrodes 6.

In addition, the plurality of signal electrodes 4, reference electrodes 5, and scanning electrodes 6 are configured such that a voltage in a predetermined voltage range between a high voltage (hereinafter, referred to as an “H voltage”) as a first voltage and a low voltage (hereinafter, referred to as an “L voltage”) as a second voltage can be applied thereto independently (details thereof will be described later).

Furthermore, in the display element 10, each of the plurality of pixel regions are hermetically compartmented by a rib (partitioning wall), and the plurality of pixel regions are provided on the display surface side according to a plurality of colors that can be used in full-color display as will be described later. In addition, in the display element 10, a polar liquid to be described later is moved using an electrowetting phenomenon so as to change a display color on the display surface side in each of a plurality of pixels (display cells) provided in a matrix shape.

In addition, one end portions of each of the plurality of signal electrodes 4, reference electrodes 5, and scanning electrodes 6 are drawn out to the outside of the effective display region of the display surface so as to form terminal portions 4a, 5a, and 6a.

Each of the terminal portions 4a of the plurality of signal electrodes 4 is connected to the signal driver 7 via wirings 7a. The signal driver 7 constitutes a signal voltage application unit, and is configured to apply a signal voltage Vd to each of the plurality of signal electrodes 4 according to information including characters and images when the image display device 1 displays the information on the display surface.

In addition, each of the terminal portions 5a of the plurality of reference electrodes 5 is connected to a reference driver 8 via wirings 8a. The reference driver 8 constitutes a reference voltage application unit, and is configured to apply a reference voltage Vr to each of the plurality of reference electrodes 5 when the image display device 1 displays information including characters and images on the display surface.

In addition, each of the terminal portions 6a of the plurality of scanning electrodes 6 is connected to a scanning driver 9 via wirings 9a. The scanning driver 9 constitutes a scanning voltage application unit, and is configured to apply a scanning voltage Vs to each of the plurality of scanning electrodes 6 when the image display device 1 displays information including characters and images on the display surface.

In addition, the scanning driver 9 is configured to apply either voltage of a non-selection voltage that prevents the polar liquid from moving or a selection voltage that allows the polar liquid to move according to the signal voltage Vd to each of the plurality of scanning electrodes 6 as the scanning voltage Vs. In addition, the reference driver 8 is configured to operate with reference to operations of the scanning driver 9, and the reference driver 8 is configured to apply either voltage of the non-selection voltage that prevents the polar liquid from moving or the selection voltage that allows the polar liquid to move according to the signal voltage Vd to each of the plurality of reference electrodes 5 as the reference voltage Vr.

Further, the image display device 1 is configured to perform scanning operations for each line in such a way that the scanning driver 9 sequentially applies the selection voltage to each of the scanning electrodes 6 disposed, for example, from the left side to the right side of FIG. 1, and the reference driver 8 is synchronized with operations of the scanning driver 9 and sequentially applies the selection voltage to each of the reference electrodes 5 disposed from the left side to the right side of FIG. 1 (details thereof will be described later).

In addition, the signal driver 7, the reference driver 8, and the scanning driver 9 include a direct current power source or an alternate current power source, and supplies the signal voltage Vd, the reference voltage Vr, and the scanning voltage Vs corresponding thereto.

In addition, the reference driver 8 is configured to switch the polarity of the reference voltage Vr at every predetermine time interval (for example, one frame). Furthermore, the scanning driver 9 is configured to switch the polarity of the scanning voltage Vs in response to the switching of the polarity of the reference voltage Vr. In this manner, since the polarities of the reference voltage Vr and the scanning voltage Vs are switched at every predetermined time interval, localization of electric charges of the reference electrodes 5 and the scanning electrodes 6 can be easily prevented in comparison to when a voltage having the same polarity is applied to the reference electrodes 5 and the scanning electrodes 6 at all times. Furthermore, an adverse effect of poor display (afterimage phenomenon) or reliability (reduced life) attributable to the localization of electric charges can be prevented.

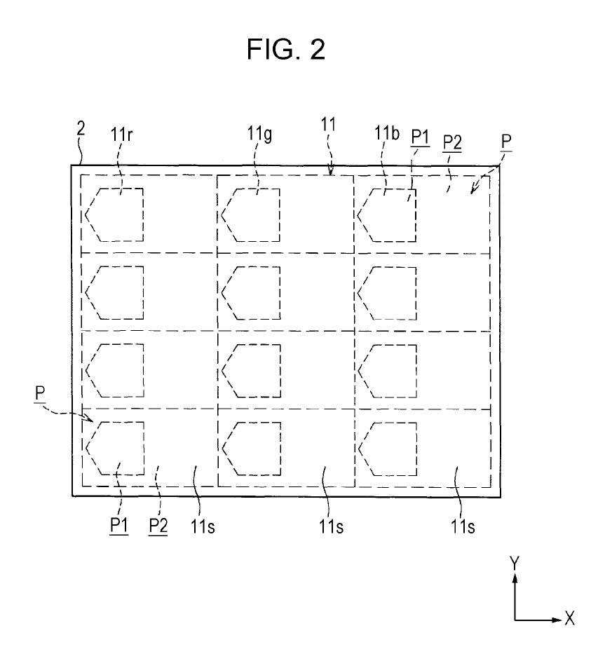

Herein, with reference to FIG. 2 to FIG. 5, a pixel configuration of the display element 10 will be described in detail.

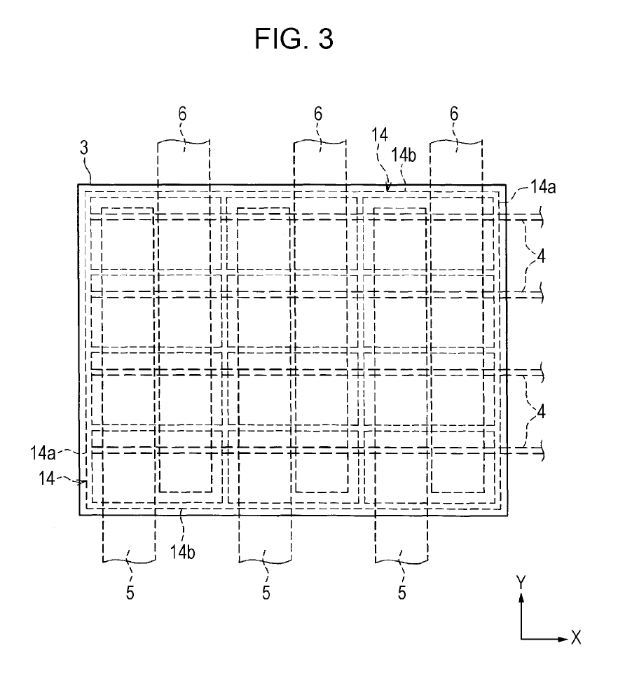

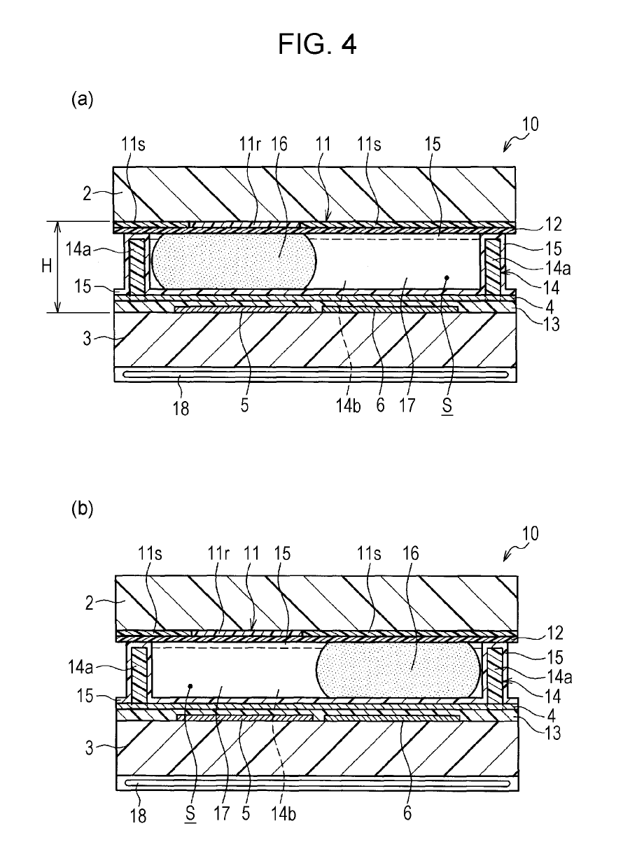

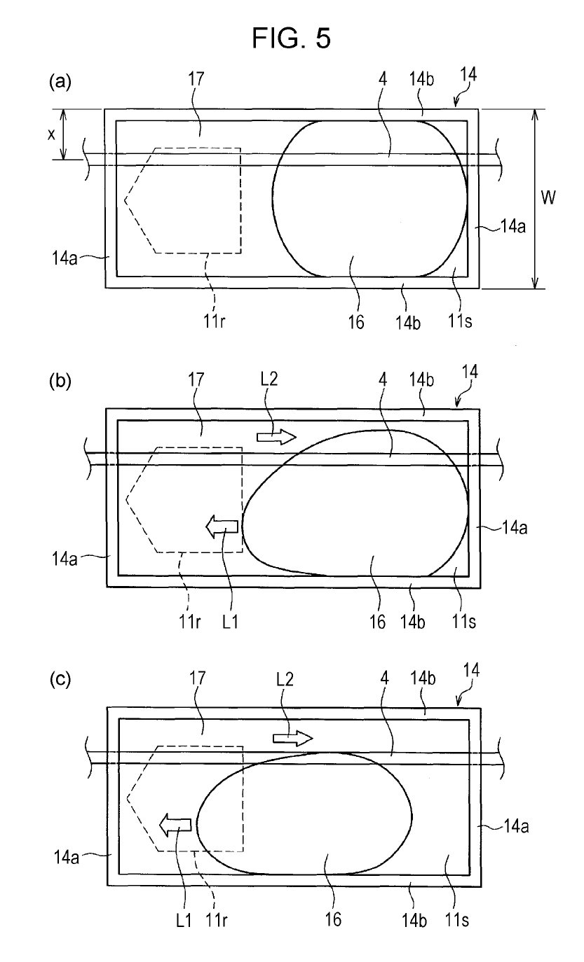

FIG. 2 is an enlarged plan view showing a configuration of main portions of the display element on the upper substrate side shown in FIG. 1 as viewed from the display surface side. FIG. 3 is an enlarged plan view showing a configuration of main portions thereof on the lower substrate side shown in FIG. 1 as viewed from a non-display surface side. FIGS. 4(a) and 4(b) are cross-sectional diagrams respectively showing a configuration of main portions of the display element shown in FIG. 1 during non-CF coloring display and CF coloring display. FIG. 5(a) is an enlarged plan view showing a configuration of main portions of the display element in one pixel region, and FIGS. 5(b) and 5(c) are diagrams describing an operation of the polar liquid and oil shown in FIG. 5(a). Note that, in order to simplify the drawings, FIGS. 2 and 3 show 12 pixels disposed in the upper left edge of FIG. 1 out of a plurality of pixels provided on the display surface.

In FIGS. 2 to 5, the display element 10 includes the upper substrate 2 as a first substrate provided on the display surface side and the lower substrate 3 as a second substrate provided on the back surface side (non-display surface side) of the upper substrate 2. In addition, in the display element 10, by disposing the upper substrate 2 and the lower substrate 3 with a predetermined gap, a predetermined display space S is formed between the upper substrate 2 and the lower substrate 3. In addition, inside each display space S, the polar liquid 16 and insulating oil 17 that does not mix with the polar liquid 16 are sealed so as to be movable in the x direction (the right-left direction of FIG. 2) of the inside of the display space S, and the polar liquid 16 is configured to be able to move on each effective display region P1 side or each non-effective display region P2 side to be described later.

Furthermore, the signal electrodes 4 are provided on the lower substrate 3 side so that a flow path of the oil 17 as an insulating fluid inside the display space S can be large when the polar liquid 16 is moved in each pixel region P inside the display space S as will be described later. In addition, the oil 17 is configured to be smoothly and appropriately moved on the effective display region P1 side or the non-effective display region P2 side according to movements of the polar liquid 16 inside the display space S.

As the polar liquid 16, for example, an aqueous solution that contains water as a solvent and a predetermined electrolyte as a solute is used. Specifically, an aqueous solution of, for example, 1 mmol/L of potassium chloride (KCl) is used as the polar liquid 16. In addition, as the polar liquid 16, a liquid that is colored in a predetermined color, for example, in black using a self-dispersible pigment is used.

In addition, since the polar liquid 16 is colored in black, the polar liquid 16 is configured to function as a shutter that allows or prohibits penetration of light in each pixel. Consequently, in each pixel of the display element 10, a display color is configured to be changed to the color of black or any color of RGB by the polar liquid 16 moving on the reference electrodes 5 side (effective display region P1 side) or the scanning electrodes 6 side (non-effective display region P2 side) in a sliding manner inside the display space S, as will be described later.

In addition, as the oil 17, for example, non-polar, not-colored and transparent oil containing one kind or a plurality of kinds selected from side-chain higher alcohol, side-chain higher fatty acid, alkane hydrocarbon, silicon oil, and matching oil is used. In addition, this oil 17 is configured to move inside the display space S according to sliding movements of the polar liquid 16.

For the upper substrate 2, a transparent glass such as an alkali-free glass substrate, or a transparent sheet material such as a transparent synthetic resin such as an acrylic resin is used. In addition, on the surface of the upper substrate 2 on the non-display surface side, a color filter layer 11 is formed. Furthermore, a water-repellent film 12 is provided so as to cover the color filter layer 11 on the surface of the upper substrate 2 on the non-display surface side.

In addition, for the lower substrate 3, a transparent glass such as an alkali-free glass substrate, or a transparent sheet material such as a transparent synthetic resin such as an acrylic resin is used in the same manner as the upper substrate 2. In addition, on the surface of the lower substrate 3 on the display surface side, the reference electrodes 5 and the scanning electrodes 6 are provided, and furthermore, a dielectric layer 13 is formed so as to cover the reference electrodes 5 and the scanning electrodes 6. Moreover, on the surface of this dielectric layer 13 on the display surface side, a rib 14 including first rib members 14a provided along the Y direction, that is, the direction vertical to the movement direction of the polar liquid 16 and second rib members 14b provided along the X direction, that is, the direction parallel to the movement direction of the polar liquid 16 are provided. The rib 14 is provided so as to hermetically compartment the inside of the display space S according to the pixel regions P, and configured to make each pixel region P have a frame shape, as shown in FIG. 3.

In addition, on the lower substrate 3, the signal electrodes 4 are formed so as to penetrate the first rib members 14a on the surface of the dielectric layer 13. Further, on the lower substrate 3, a water-repellent film 15 is provided so as to cover the signal electrodes 4, the dielectric layer 13, and the first and the second rib members 14a and 14b.

In addition, on the back surface side (non-display surface side) of the lower substrate 3, a backlight 18 that emits, for example, white illumination light is installed in an integrated manner, and thereby the transmission type display element 10 is configured. Note that, for the backlight 18, a light source such as a cold-cathode fluorescent tube, or LEDs is used.

On the color filter layer (11), red (R), green (G), and blue (B) color filter portions 11r, 11g, and 11b and black matrix portions 11s as light-shielding films are provided so as to constitute pixels having each color of RGB. In other words, on the color filter layer 11, the RGB color filter portions 11r, 11g, and 11b are sequentially provided along the X direction, and respective four more color filter portions 11r, 11g, and 11b are provided along the Y direction as shown in FIG. 2, and thereby three and four color filter portions in the X direction and the Y direction respectively, which are 12 pixels in total are arranged.

In addition, in the display element 10, any one of the RGB color filter portions 11r, 11g, and 11b is provided on a spot corresponding to each effective display region P1 of a pixel, and each black matrix portions 11s is provided on a spot corresponding to each non-effective display region P2 thereof in each of the pixel regions P as shown in FIG. 2. After all, in the display element 10, the non-effective display region P2 (non-aperture) is set by the black matrix portion (light-shielding film) 11s, and the effective display region P1 is set by an aperture (in other words, any one of the color filter portions 11r, 11g, and 11b) formed in the black matrix portion 11s in the display space S.

In addition, in the display element 10, for the areas of the respective color filter portions 11r, 11g, and 11b, a value which is the same as or a slightly smaller than the area of the effective display region P1 is selected. On the other hand, for the area of the black matrix portion 11s, a value which is the same as or a slightly smaller than the area of the non-effective display region P2 is selected. Note that, in order to clarify the boundary of adjacent pixels in FIG. 2, the boundary line between two black matrix portions 11s in adjacent pixels is indicated by a dotted line, but in the color filter layer 11 in reality, the boundary line between the black matrix portions 11s does not exist.

In addition, in the display element 10, the display space S is compartmented by the rib 14 as a partition wall in a unit of pixel regions P. In other words, in the display element 10, the display space S of each pixel is compartmented by two first rib member 14a facing each other and two second rib members 14b facing each other as shown in FIG. 3, and the rib 14 of a frame shape is provided in each pixel region P. Furthermore, in the display element 10, the first and the second rib members 14a and 14b are provided so that the ends thereof are brought into contact with the upper substrate 2, and thereby the rib 14 is configured to hermetically compartment the inside of the display space S in each pixel region P. In addition, for the first and the second rib members 14a and 14b, for example, an epoxy resin-based resist material is used.

For the water-repellent films 12 and 15, a transparent synthetic resin, or preferably a resin that serves as a hydrophilic layer for the polar liquid 16 during voltage application, for example, a fluorine-based resin is used. Accordingly, in the display element 10, wettability (contact angle) between the upper substrate 2 and the polar liquid 16 on the surface side of each display space S of the lower substrate 3 can be significantly changed, and thereby the movement speed of the polar liquid 16 can be increased. In addition, the dielectric layer 13 is constituted by a transparent dielectric film containing, for example, parylene, silicon nitride, hafnium oxide, zinc oxide, titanium dioxide, or aluminum-oxide. Note that the specific thickness of each of the water-repellent films 12 and 15 is dozens nm to several μm, and the specific thickness of the dielectric layer 13 is hundreds nm. In addition, the water-repellent film 15 is set not to hinder the enhancement of responsiveness of the polar liquid 16 without electrically insulating the signal electrodes 4 and the polar liquid 16.

For the reference electrodes 5 and the scanning electrode 6, a transparent electrode material such as an indium oxide (ITO)-based, a tin oxide (SnO2)-based, or a zinc oxide (AZO, GZO, or IZO)-based material is used. The reference electrodes 5 and the scanning electrode 6 are formed in stripe shapes on the lower substrate 3 using a known film forming method such as a sputtering method.

For the signal electrodes 4, linear wirings disposed in parallel with the X direction are used. In addition, for the signal electrodes 4, a transparent electrode material such as ITO is used, and the signal electrodes 4 are formed in a straight line shape along the direction parallel to the movement direction of the polar liquid 16 on the dielectric layer 13 using a known film forming method such as the sputtering method or printing. In addition, the signal electrodes 4 are configured to penetrate the first rib members 14a and to come into electrically contact with the polar liquid 16 inside the display space S via the water-repellent film 15 on the dielectric layer 13. Accordingly, in the display element 10, the enhancement of the responsiveness of the polar liquid 16 during a display operation can be attained.

Furthermore, the signal electrodes 4 are provided on the lower substrate 3 side so that the flow path of the oil 17 inside the display space S becomes large when the polar liquid 16 inside the display space S is moved in each pixel region P.

Herein, with reference also to FIGS. 5(a), 5(b), and 5(c), the installation spots of the signal electrodes 4 and the effect will be described in detail.

As shown in FIGS. 3 and 5(a), each signal electrode 4 is disposed on the second rib member 14b side, not the center of the Y direction, which is the direction vertical to the movement direction of the polar liquid 16. By disposing the signal electrode 4 in a location difference from the center in the Y direction in this manner, the flow path of the oil 17 inside the display space S becomes large when the polar liquid 16 is moved inside the display space S.

To describe in detail, when the size of the separation between the upper substrate 2 and the lower substrate 3 is set to H (FIG. 4(a)), the size of the interval between two second rib members 14b compartmenting the pixel region P is set to W (FIG. 5(a)), and the distance between one of the second rib member 14b and the center line of the signal electrode 4 in the direction vertical to the movement direction of the polar liquid 16 is set to x (FIG. 5(a)), the signal electrode 4 is provided so as to satisfy the following inequality (1).

H/2<x<W/4 (1)

As described above since the signal electrode 4 is disposed in each pixel region P so as to satisfy the above inequality (1), the flow path of the polar liquid 16 is not formed, but the flow path of the oil (insulating fluid) 17 is formed immediately above and in the periphery of the signal electrode 4. In other words, on the lower substrate (either of the first or the second substrate) 3 side on which the reference electrodes 5 and the scanning electrodes 6 are provided, wettability (contact angle) of the polar liquid 16 on the portion in which the signal electrode 4 is provided resulting from an electrowetting phenomenon which occurs during a movement of the polar liquid 16 does not change. For this reason, the periphery of the signal electrode 4 can be secured as the flow path of the oil 17, not as the flow path of the polar liquid 16, and thereby the flow path of the oil 17 can be increased.

To describe in more detail, when a voltage that causes the polar liquid 16 to move from the position shown in FIG. 5(a) to the left side (the color filter portion 11r side) of the same FIG. 5(a) is applied to each of the signal electrodes 4, the reference electrode 5, and the scanning electrodes 6, the wettability (contact angle) of the polar liquid 16 on the surface of the dielectric layer 13 that covers the reference electrode 5 and the scanning electrode 6 on the lower substrate 3 changes due to the electrowetting phenomenon except the portion in which the signal electrode 4 is disposed. Accordingly, as shown in FIG. 5(b), the polar liquid 16 is moved in the direction indicated by the arrow L1 while being transformed toward the lower side portion of FIG. 5(b) in which the signal electrode 4 is not provided. As a result, inside the display space S, the flow path of the oil 17 can be secured in the upper side portion of FIG. 5(b) in the periphery of the signal electrode 4, and the oil 17 thereby is moved in the direction indicated by the arrow L2 along the flow path.

Furthermore, the polar liquid 16 is moved in the direction indicated by the arrow L1 while being transformed toward the lower side portion of FIG. 5(c) as shown in FIG. 5(c). As a result, inside the display space S, the flow path of the oil 17 can be secured more in the upper side portion of FIG. 5(c) in the periphery of the signal electrode 4, and the oil 17 is thereby moved in the direction indicated by the arrow L2.

In addition, in the present embodiment, since the size x for the signal electrode 4 is set to a value greater than H/2 as shown in the above inequality (1), it is possible to reliably prevent the signal electrode 4 and the polar liquid 16 from being in a non-contact state. As a result, stop of the movement of the polar liquid 16, which is caused by no occurrence of the electrowetting phenomenon due to the polar liquid 16 coming into non-contact with the signal electrode 4 when the polar liquid 16 is to be moved, can be reliably averted.

In addition, in the present embodiment, since the size x for the signal electrode 4 is set to a value smaller than W/4 as shown in the above inequality (1), the flow path of the oil 17 can be assuredly increased. As a result, when the polar liquid 16 is moved, the polar liquid 16 and the oil 17 can be smoothly and appropriately moved.

Note that, when the size x is set to a value equal to or lower than H/2, there is concern that the signal electrode 4 and the polar liquid 16 is in a non-contact state, and when the polar liquid 16 is moved, the electrowetting phenomenon does not occur, and accordingly, there is concern that the polar liquid 16 cannot be moved.

In addition, when the size x is set to a value equal to or higher than W/4, the signal electrode 4 is disposed near the center of the Y direction, and accordingly, there is concern that the flow path of the oil 17 cannot be assuredly increased.

In each pixel of the display element 10 configured as above, when the polar liquid 16 is held between the color filter portion 11r and the reference electrode 5 as shown in FIG. 4(a), light emitted from the backlight 18 is blocked by the polar liquid 16, and thereby black color is displayed (non-CF coloring display). On the other hand, when the polar liquid 16 is held between the black matrix portion 11s and the scanning electrode 6 as shown in FIG. 4(b), light emitted from the backlight 18 passes through the color filter portion 11r without being blocked by the polar liquid 16, and thereby red color is displayed (CF coloring display).

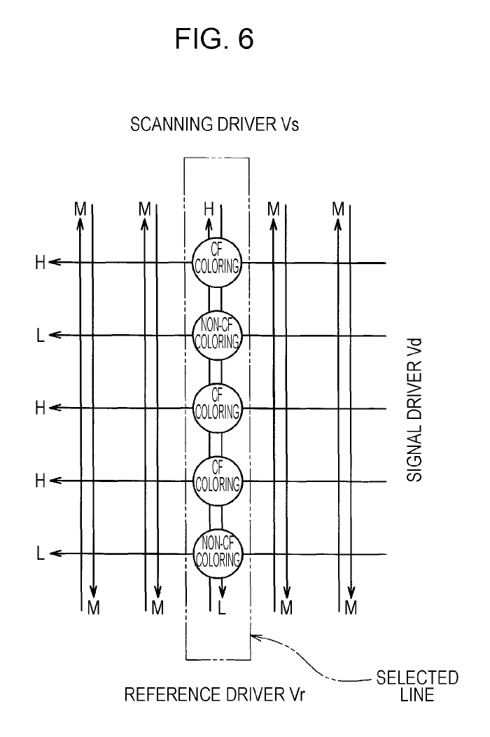

Next, a display operation of the image display device 1 according to the present embodiment configured as above will be described in detail with reference also to FIG. 6.

FIG. 6 is a diagram describing an operation example of the image display device.

In FIG. 6, the reference driver 8 and the scanning driver 9 respectively apply the selection voltages as the reference voltage Vr and the scanning voltage Vs to respective one of the reference electrodes 5 and the scanning electrode 6 in a sequential manner in, for example, a predetermined scanning direction from the left side to the right side of the drawing. To be specific, the reference driver 8 and the scanning driver 9 respectively apply H voltages (first voltages) and L voltages (second voltages) to the reference electrode 5 and the scanning electrode 6 as the selection voltages in a sequentially manner to perform a scanning operation to set a selected line. In addition, on this selected line, the signal driver 7 applies the H voltage or the L voltage to a corresponding signal electrode 4 as the signal voltage Vd according to image input signals from outside. Accordingly, in each pixel on the selected line, the polar liquid 16 is moved on the effective display region P1 side or the non-effective display region P2 side, and accordingly, a display color on the display surface is changed. In addition, at this moment, according to the movement of the polar liquid 16, the oil 17 is moved on the non-effective display region P2 side or the effective display region P1 side which is the opposite side of the movement destination of the polar liquid 16.

On the other hand, to non-selected lines, in other words, all of the remaining reference electrodes 5 and scanning electrodes 6, the reference driver 8 and the scanning driver 9 respectively apply the non-selection voltage as the reference voltage Vr and the scanning voltage Vs. To be more specific, the reference driver 8 and the scanning driver 9 apply, for example, an intermediate voltage (or middle voltage, and hereinafter, referred to as an “M voltage”) which is in the middle of the H voltage and the L voltage to all of the remaining reference electrodes 5 and the scanning electrodes 6 as the non-selection voltage. Accordingly, in each pixel of the non-selected lines, the polar liquid 16 stands still without causing an unnecessary change on the effective display region P1 side or the non-effective display region P2 side, and thereby a display color on the display surface is not changed.

When the display operation is performed as described above, a combination of voltages applied to the reference electrodes 5, the scanning electrode 6, and the signal electrodes 4 is as shown in Table 1. Furthermore, behaviors of the polar liquid 16 and display colors on the display surface are in accordance with the applied voltages as shown in Table 1. Note that, in Table 1, the H voltage, the L voltage, and the M voltage are respectively abbreviated to “H”, “L”, and “M” (the same is applied also to Table 2 shown later). In addition, specific values of the H voltage, the L voltage, and the M voltage are respectively, for example, +16V, 0V, and +8V.

TABLE 1

| | | | | Behavior of Polar |
|---|---|---|---|---|
| | | | | Liquid, and Display |
| | Reference | Scanning | Signal | Color on Display |
| | Electrode | Electrode | Electrode | Surface |
| Selected | H | L | H | Moves on scanning |
| Line | | | | electrode side |
| | | | | CF coloring display |
| | | | L | Moves on reference |
| | | | | electrode side |
| | | | | Black color display |
| Non- | M | M | H | Stands still (no |
| Selected | | | L | movement) |
| Line | | | | Either black color |
| | | | | or CF coloring |
| | | | | display |

<Operation on Selected Line>

On a selected line, since the H voltage is applied to both of the reference electrode 5 and the signal electrode 4 when, for example, the H voltage is applied to the signal electrode 4, an electric potential difference does not occur between the reference electrode 5 and the signal electrode 4. On the other hand, since the L voltage is applied to the scanning electrode 6, there is an electric potential difference occurring between the signal electrode 4 and the scanning electrode 6. For this reason, the polar liquid 16 is moved inside the display space S on the scanning electrode 6 side in which an electric potential difference between the signal electrode 4 occurs. As a result, the polar liquid 16 is moved on the non-effective display region P2 side, causing the oil 17 to move on the reference electrode 5 side as shown in FIG. 4(b), and thereby allowing illumination light emitted from the backlight 18 to reach the color filter portion 11r. Accordingly, the display color on the display surface is in a red color display (CF coloring display) state due to the color filter portion 11r. In addition, in the image display device 1, when the polar liquid 16 is moved on the non-effective display region P2 side in adjacent all three RGB pixels, and thereby CF coloring display is performed, red light, green light, and blue light from the RGB pixels are mixed with white light, and white color display is performed.

On the other hand, on the selected line, when the L voltage is applied to the signal electrode 4, an electric potential difference occurs between the reference electrode 5 and the signal electrode 4, but an electric potential difference does not occur between the signal electrode 4 and the scanning electrode 6. Thus, the polar liquid 16 is moved inside the display space S on the reference electrode 5 side in which the electric potential difference occurs between the signal electrode 4. As a result, the polar liquid 16 is moved on the effective display region P1 side as shown in FIG. 4(a), and thereby hindering illumination light emitted from the backlight 18 from reaching the color filter portion 11r. Accordingly, the display color on the display surface is in a black color display (non-CF coloring display) state due to the polar liquid 16.

<Operation on Non-Selected Line>

On a non-selected line, when, for example, the H voltage is applied to the signal electrode 4, the polar liquid 16 maintains to stand still on a current position, and a current display color is maintained. In other words, since the M voltage is applied to both of the reference electrode 5 and the scanning electrode 6, an electric potential difference between the reference electrode 5 and the signal electrode 4 is the same as that between the scanning electrode 6 and the signal electrode 4. As a result, the display color is maintained without being changed from current black color display or CF coloring display.

In the same manner, even when the L voltage is applied to the signal electrode 4 on the non-selected line, the polar liquid 16 maintains to stand still on a current position, and a current display color is maintained. In other words, since the M voltage is applied to both of the reference electrode 5 and the scanning electrode 6, an electric potential difference between the reference electrode 5 and the signal electrode 4 is the same as that between the scanning electrode 6 and the signal electrode 4.

As described above, on the non-selected line, even when any voltage of the H voltage and the L voltage is applied to the signal electrode 4, the polar liquid 16 stands still without moving, and thereby a display color on the display surface is not changed.

On the other hand, on the selected line, the polar liquid 16 can be moved according to a voltage applied to the signal electrode 4 as described above, and thereby a display color on the display surface can be changed.

In addition, in the image display device 1, a display color in each pixel on the selected line is CF-colored (red, green, or blue) due to the color filter portions 11r, 11g, and 11b or non-CF-colored (black) due to the polar liquid 16 according to a voltage applied to the corresponding signal electrode 4 in each pixel as shown in, for example, FIG. 6 based on the combination of the applied voltages shown in Table 1. In addition, when the reference driver 8 and the scanning driver 9 performs a scanning operation for the selected line of the reference electrode 5 and the scanning electrode 6, for example, from the left side to the right side of FIG. 6, the display color of each pixel in the display unit of the image display device 1 is also sequentially changed from the left side to the right side of FIG. 6. Thus, by accelerating the scanning operation of the selected line by the reference driver 8 and the scanning driver 9, the display color of each pixel in the display unit can be quickly changed in the image display device 1. Furthermore, by applying the signal voltage Vd to the signal electrode 4 in synchronization with the scanning operation of the selected line, various kinds of information including a moving image can be displayed in the image display device 1 based on image input signals from outside.

In addition, the combination of the voltages applied to the reference electrode 5, the scanning electrodes 6, and the signal electrode 4 is not limited to Table 1, and may be as shown in Table 2.

TABLE 2

| | | | | Behavior of Polar |
|---|---|---|---|---|
| | | | | Liquid, and Display |
| | Reference | Scanning | Signal | Color on Display |
| | Electrode | Electrode | Electrode | Surface |
| Selected | L | H | L | Moves on scanning |
| Line | | | | electrode side |
| | | | | CF coloring display |
| | | | H | Moves on reference |
| | | | | electrode side |
| | | | | Black color display |
| Non- | M | M | H | Stands still (no |
| Selected | | | L | movement) |
| Line | | | | Either black color |
| | | | | or CF coloring |
| | | | | display |

In other words, the reference driver 8 and the scanning driver 9 respectively apply the L voltages (second voltages) and the H voltages (first voltages) to the reference electrode 5 and the scanning electrode 6 as the selection voltages in a sequentially manner in, for example, a predetermined scanning direction from the left side to the right side of the drawing to perform a scanning operation to set a selected line. In addition, on this selected line, the signal driver 7 applies the H voltage or the L voltage to a corresponding signal electrode 4 as the signal voltage Vd according to image input signals from outside.

On the other hand, to non-selected lines, in other words, all of the remaining reference electrodes 5 and scanning electrodes 6, the reference driver 8 and the scanning driver 9 apply the M voltage as a non-selection voltage.

<Operation on Selected Line>

On a selected line, since the L voltage is applied to both of the reference electrode 5 and the signal electrode 4 when, for example, the L voltage is applied to the signal electrode 4, an electric potential difference does not occur between the reference electrode 5 and the signal electrode 4. On the other hand, since the H voltage is applied to the scanning electrode 6, there is an electric potential difference occurring between the signal electrode 4 and the scanning electrode 6. Thus, the polar liquid 16 is moved inside the display space S on the scanning electrode 6 side in which an electric potential difference between the signal electrode 4 occurs. As a result, the polar liquid 16 is moved on the non-effective display region P2 side, causing the oil 17 to move on the reference electrode 5 side as shown in FIG. 4(b), and thereby allowing illumination light emitted from the backlight 18 to reach the color filter portion 11r. Accordingly, the display color on the display surface is in a red color display (CF coloring display) state due to the color filter portion 11r. In addition, when CF coloring display is performed in all adjacent three RGB pixels, white color display is performed in the same manner as shown in Table 1.

On the other hand, on the selected line, when the H voltage is applied to the signal electrode 4, an electric potential difference occurs between the reference electrode 5 and the signal electrode 4, but an electric potential difference does not occur between the signal electrode 4 and the scanning electrode 6. Thus, the polar liquid 16 is moved inside the display space S on the reference electrode 5 side in which the electric potential difference occurs between the signal electrode 4. As a result, the polar liquid 16 is moved on the effective display region P1 side as shown in FIG. 4(a), and thereby hindering illumination light emitted from the backlight 18 from reaching the color filter portion 11r. Accordingly, the display color on the display surface is in a black color display (non-CF coloring display) state due to the polar liquid 16.

<Operation on Non-Selected Line>

On a non-selected line, when, for example, the L voltage is applied to the signal electrode 4, the polar liquid 16 maintains to stand still on a current position, and a current display color is maintained. In other words, since the M voltage is applied to both of the reference electrode 5 and the scanning electrode 6, an electric potential difference between the reference electrode 5 and the signal electrode 4 is the same as that between the scanning electrode 6 and the signal electrode 4. As a result, the display color is maintained without being changed from current black color display or CF coloring display.

In the same manner, even when the H voltage is applied to the signal electrode 4 on the non-selected line, the polar liquid 16 maintains to stand still on a current position, and a current display color is maintained. In other words, since the M voltage is applied to both of the reference electrode 5 and the scanning electrode 6, an electric potential difference between the reference electrode 5 and the signal electrode 4 is the same as that between the scanning electrode 6 and the signal electrode 4.

As described above, also in the case shown in Table 2, even when any voltage of the H voltage and the L voltage is applied to the signal electrode 4 on the non-selected line, the polar liquid 16 stands still without moving, and thereby a display color on the display surface is not changed in the same manner as in the case shown in Table 1.

On the other hand, on the selected line, the polar liquid 16 can be moved according to a voltage applied to the signal electrode 4 as described above, and thereby a display color on the display surface can be changed.

In addition, in the image display device 1 according to the present embodiment, as a voltage to be applied to the signal electrode 4 can also be changed to a voltage between the H voltage and the L voltage on top of the two values of the H voltage and the L voltage according to information displayed on the display surface, in addition to the combination of applied voltages shown in Tables 1 and 2. In other words, in the image display device 1, grayscale display is possible by controlling the signal voltage Vd. Accordingly, the display element 10 that has excellent display performance can be configured.

In the display element 10 configured as above according to the present embodiment, the inside of the display space S is hermetically compartmented by the rib 14 according to each of the plurality of pixel regions P. Accordingly, in the display element 10 according to the present embodiment, the oil (insulating fluid) 17 can be prevented from coming in the space from an adjacent pixel region P, and thereby an occurrence of a fine movement of the polar liquid 16 caused by the oil 17 coming from the adjacent pixel region P can be prevented, unlike in the example of the related art described above. In addition, in the display element 10 according to the present embodiment, when the polar liquid 16 is moved inside the display space S for each pixel region P, the signal electrode 4 is provided on the lower substrate (either of the first or the second substrate) 3 side so that the flow path of the oil 17 inside the display space S can be large. Thus, in the display element 10 according to the present embodiment, the peripheral portion of the signal electrode 4 can be secured as the flow path of the oil 17, not as the flow path of the polar liquid 16 as shown in FIGS. 5(b) and 5(c), and thereby the flow path of the oil 17 can be large. As a result, even when the polar liquid 16 is to be moved to change a display color in the display element 10 according to the present embodiment, the polar liquid 16 can be smoothly and appropriately moved. Thus, the display element 10 that can prevent degradation of display quality can be configured in the present embodiment even when grayscale display is performed, unlike in the example of the related art.

In addition, in the present embodiment, since the signal electrodes 4 are linearly provided along the direction parallel with the movement direction of the polar liquid 16, the large flow path of the oil 17 can be secured along the direction parallel with the movement direction of the polar liquid 16, and thereby the polar liquid 16 can be smoothly and appropriately moved.

In addition, in the image display device (electrical apparatus) 1 according to the present embodiment, since the display element 10 that can prevent degradation of display quality is used in the display unit even when grayscale display is performed, the high-performance image display device (electrical apparatus) 1 that has the display unit exhibiting excellent display quality can be easily configured.

In addition, in the display element 10 according to the present embodiment, the signal driver (signal voltage application unit) 7, the reference driver (reference voltage application unit) 8, and the scanning driver (scanning voltage application unit) 9 are set to apply the signal voltage Vd, the reference voltage Vr, and the scanning voltage Vs to the signal electrode 4, the reference electrode 5, and the scanning electrodes 6. Accordingly, in the present embodiment, the display element 10 of a matrix drive type exhibiting excellent display quality can be easily configured, and display colors in each pixel region can be appropriately changed.

### Second Embodiment

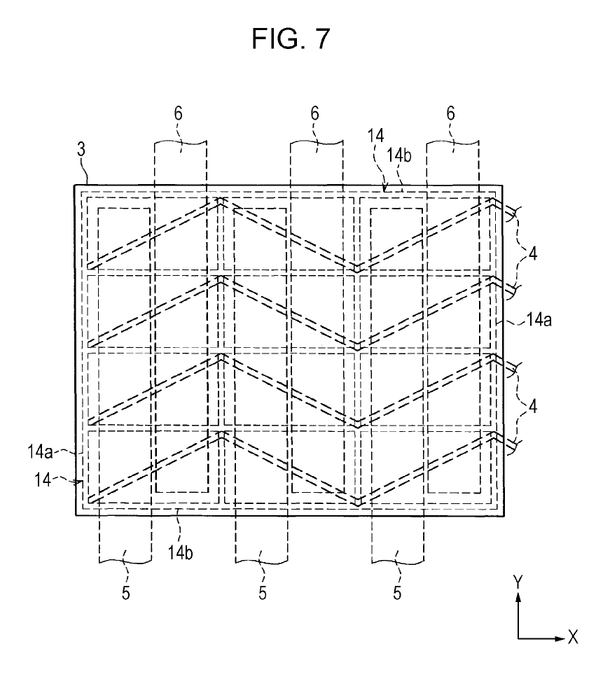

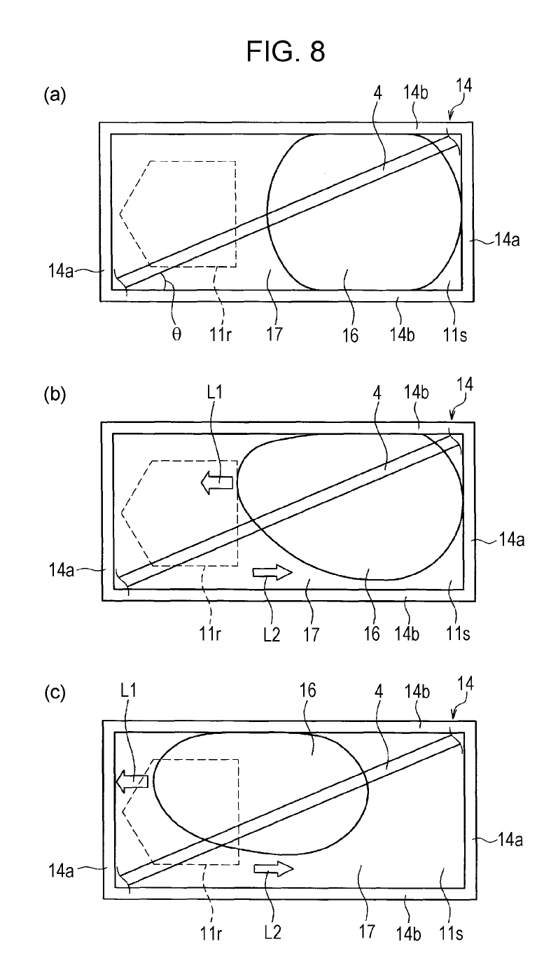

FIG. 7 is an enlarged plan view showing a configuration of main portions of a display element according to a second embodiment of the present invention on a lower substrate side as viewed from a non-display surface side. FIG. 8(a) is an enlarged plan view showing a configuration of main portions of the display element shown in FIG. 7 in one pixel region, and FIGS. 8(b) and 8(c) are diagrams describing an operation of the polar liquid and oil shown in FIG. 8(a). The important difference of the present embodiment from the first embodiment in the drawings, each signal electrode 4 is provided so as to form a predetermined angle θ with the movement direction of the polar liquid 16. Note that overlapping description will not be repeated by giving the same reference numerals to the common constituent elements to those in the first embodiment.

In other words, in the display element 10 according to the present embodiment, each signal electrode 4 is provided so as to form the predetermined angle θ with the movement direction of the polar liquid 16 in each pixel region P as shown in FIGS. 7 and 8(a). Accordingly, the peripheral portion of the signal electrode 4 is secured as the flow path of the oil 17 in the display element 10 according to the present embodiment, and thereby the flow path of the oil 17 can be increased.

To describe in more detail, when a voltage is applied to each signal electrode 4, reference electrode 5, and scanning electrode 6 to cause the polar liquid 16 to move from the position shown in FIG. 8(a) to the left side (color filter portion 11r side) of FIG. 8(a), wettability (contact angle) of the polar liquid 16 on the surface of the dielectric layer 13 that covers the reference electrode 5 and the scanning electrode 6 on the lower substrate 3 changes due to the electrowetting phenomenon except for the portion in which the signal electrode 4 is disposed. Accordingly, the polar liquid 16 is moved in the direction indicated by the arrow L1 while transforming toward the upper side portion of FIG. 8(b) in which the signal electrode 4 is not provided in the movement direction of the polar liquid 16 as shown in FIG. 8(b). As a result, in the peripheral portion of the signal electrode 4, the flow path of the oil 17 can be secured in the lower side portion of FIG. 8(b) inside the display space S, and the oil 17 is moved in the direction indicated by the arrow L2 along the flow path.

Furthermore, as shown in FIG. 8(c), the polar liquid 16 is moved in the direction indicated by the arrow L1 while transforming toward the upper side portion of FIG. 8(c). As a result, in the peripheral portion of the signal electrode 4, the flow path of the oil 17 can be further secured in the lower side portion of FIG. 8(c) inside the display space S, and the oil 17 is moved in the direction indicated by the arrow L2.

In addition, since the predetermined angle θ is set for the signal electrode 4 so that the signal electrode 4 is provided on a diagonal of the pixel region formed in a rectangular shape as shown in FIG. 8(a), the polar liquid 16 comes into contact with the signal electrode 4 at all times.

With the above configuration, the same effects and advantages as those in the first embodiment can be exhibited in the present embodiment. In addition, since the signal electrode 4 is provided so as to form the predetermined angle θ with the movement direction of the polar liquid 16 in the present embodiment, a non-contact state of the signal electrode 4 with the polar liquid 16 can be reliably prevented, and the large flow path of the oil (insulting fluid) 17 can thereby be secured.

### Third Embodiment

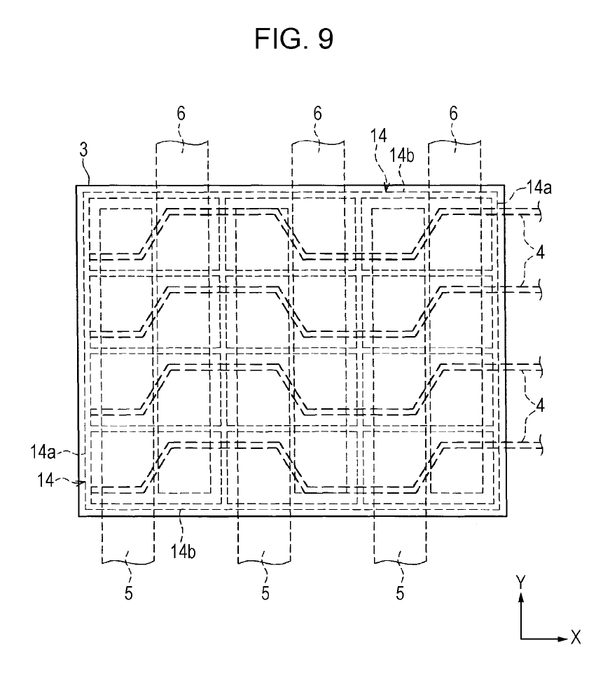

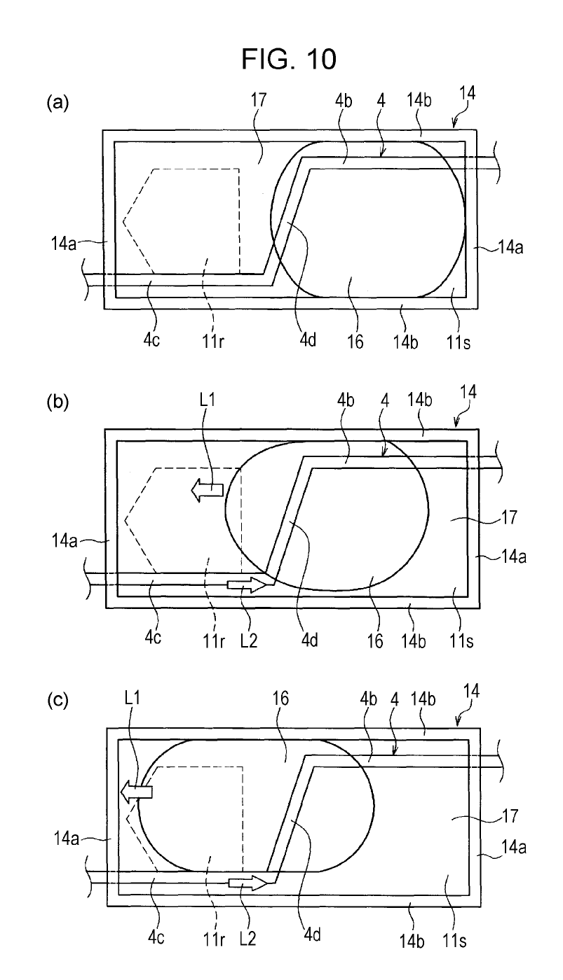

FIG. 9 is an enlarged plan view showing a configuration of main portions of a display element according to a third embodiment of the present invention on a lower substrate side as viewed from a non-display surface side. FIG. 10(a) is an enlarged plan view showing a configuration of main portions of the display element shown in FIG. 9 in one pixel region, and FIGS. 10(b) and 10(c) are diagrams describing an operation of the polar liquid and oil shown in FIG. 10(a). The important difference of the present embodiment from the second embodiment in the drawings is that one end portion and the other end portion of each signal electrode are provided so as to be respectively on one end portion and the other end portion side in each pixel region in the direction vertical to the movement direction of the polar liquid. Note that overlapping description will not be repeated by giving the same reference numerals to the common constituent elements to those in the second embodiment.

In other words, as shown in FIG. 9, one end portion and the other end portion of the signal electrode 4 are provided so as to be respectively on one end portion and the other end portion side in each pixel region P in the direction vertical to the movement direction of the polar liquid 16 (Y direction) in the display element 10 according to the present embodiment.

To describe in more detail, the signal electrode 4 includes one end portion 4b provided on one end portion side in the pixel region P (on the upper side of FIG. 10(a)), the other end portion 4c provided on the other end portion side in the pixel region P (on the lower side of FIG. 10(a)), and a middle portion 4d that is provided so as to slant to the one end portion 4b and the other end portion 4c and connects the one end portion 4b and the other end portion 4c as shown in FIG. 10(a). Accordingly, a peripheral portion of the signal electrode 4 can be secured as the flow path of the oil 17, thereby increasing the flow path of the oil 17 in the display element 10 according to the present embodiment.

To describe in more detail, when a voltage is applied respectively to the signal electrode 4, the reference electrode 5, and the scanning electrode 6 to cause the polar liquid 16 to move from the position shown in FIG. 10(a) to the left side (color filter portion 11r side) of FIG. 10(a), wettability (contact angle) of the polar liquid 16 on the surface of the dielectric layer 13 that covers the reference electrode 5 and the scanning electrode 6 on the lower substrate 3 is changed due to the electrowetting phenomenon except in the portion in which the signal electrode 4 is disposed. Accordingly, the polar liquid 16 is moved in the direction indicated by the arrow L1 while transforming toward the upper side portion of FIG. 10(b) in which the other end portion 4c of the signal electrode 4 is not provided in the movement direction of the polar liquid 16 as shown in FIG. 10(b). As a result, the flow path of the oil 17 can be secured in the lower side portion of FIG. 10(b) in the periphery of the signal electrode 4, and the oil 17 is thereby moved in the direction indicated by the arrow L2 along the flow path inside the display space S.

Furthermore, as shown in FIG. 10(c), the polar liquid 16 is moved in the direction indicated by the arrow L1 while transforming toward the upper side portion of FIG. 10(c). As a result, the flow path of the oil 17 can be further secured in the lower side portion of FIG. 10(c) in a peripheral portion of the signal electrode 4, and the oil 17 is thereby moved in the direction indicated by the arrow L2 inside the display space S.

In addition, since the one end portion 4b, the other end portion 4c, and the middle portion 4d are provided in the signal electrode 4 as shown in FIG. 10(a), the polar liquid 16 comes into contact with the signal electrode 4 at all times. Furthermore, since the other end portion 4c in the signal electrode 4 is provided so as not to overlap with the color filter portion 11r, that is, an aperture as shown in FIG. 10(a), a reduction in luminance due to the signal electrode 4 can be prevented, unlike in the second embodiment.

With the above configuration, the same effects and advantages as those in the second embodiment can be exhibited in the present embodiment. In addition, in the present embodiment, the one end portion 4b and the other end portion 4c of the signal electrode 4 are provided so as to be respectively on the one end portion side and the other end portion side in each pixel region P in the direction vertical to the movement direction of the polar liquid 16. Accordingly, in the present embodiment, the large flow path of the oil (insulating fluid) 17 can be secured while being in a non-contact state of the signal electrode 4 and the polar liquid 16 can be reliability prevented.

### Fourth Embodiment

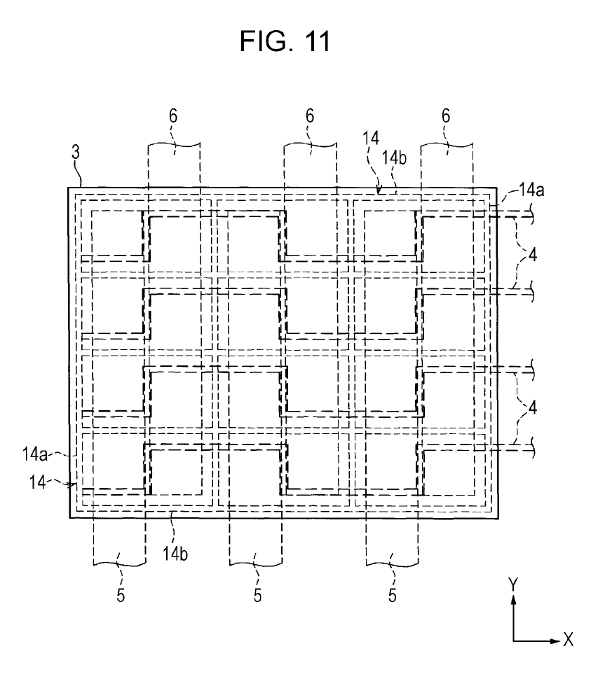

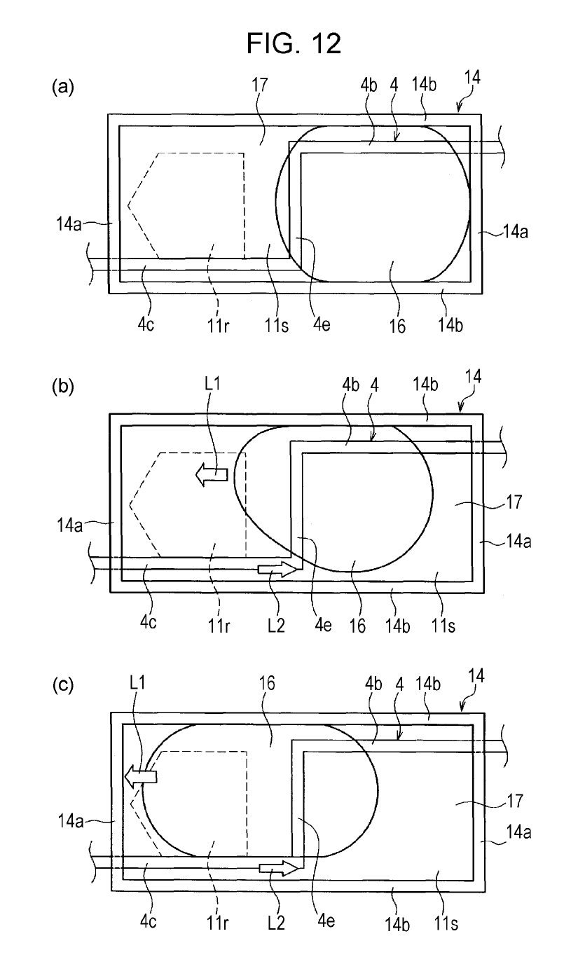

FIG. 11 is an enlarged plan view showing a configuration of main portions of a display element according to a fourth embodiment of the present invention on a lower substrate side as viewed from a non-display surface side. FIG. 12(a) is an enlarged plan view showing a configuration of main portions of the display element shown in FIG. 11 in one pixel region, and FIGS. 12(b) and 12(c) are diagrams describing an operation of the polar liquid and oil shown in FIG. 12(a). An important difference of the present embodiment from the third embodiment in the drawings is that a middle portion 4e provided so as to be vertical to the one end portion 4b and the other end portion 4c is used instead of the middle portion 4d provided so as to slant to the one end portion 4b and the other end portion 4c in the signal electrode 4. Note that overlapping description will not be repeated by giving the same reference numerals to the common constituent elements to those in the third embodiment.

In other words, as shown in FIG. 11, one end portion and the other end portion of the signal electrode 4 are provided so as to be respectively on one end portion and the other end portion side in each pixel region P in the direction vertical to the movement direction of the polar liquid 16 (Y direction) in the display element 10 according to the present embodiment.

To describe in more detail, the signal electrode 4 includes the one end portion 4b provided on one end portion side in the pixel region P (on the upper side of FIG. 12(a)), the other end portion 4c provided on the other end portion side in the pixel region P (on the lower side of FIG. 12(a)), and the middle portion 4e that is provided so as to be orthogonal respectively to the one end portion 4b and the other end portion 4c and connects the one end portion 4b and the other end portion 4c as shown in FIG. 12(a). Accordingly, a peripheral portion of the signal electrode 4 can be secured as the flow path of the oil 17, thereby increasing the flow path of the oil 17 in the display element 10 according to the present embodiment.

To describe in more detail, when a voltage is applied respectively to the signal electrode 4, the reference electrode 5, and the scanning electrode 6 to cause the polar liquid 16 to move from the position shown in FIG. 12(a) to the left side (color filter portion 11r side) of FIG. 12(a), wettability (contact angle) of the polar liquid 16 on the surface of the dielectric layer 13 that covers the reference electrode 5 and the scanning electrode 6 on the lower substrate 3 is changed due to the electrowetting phenomenon except in the portion in which the signal electrode 4 is disposed. Accordingly, the polar liquid 16 is moved in the direction indicated by the arrow L1 while transforming toward the upper side portion of FIG. 12(b) in which the other end portion 4c of the signal electrode 4 is not provided in the movement direction of the polar liquid 16 as shown in FIG. 12(b). As a result, the flow path of the oil 17 can be secured in the lower side portion of FIG. 12(b) in the periphery of the signal electrode 4, and the oil 17 is thereby moved in the direction indicated by the arrow L2 along the flow path inside the display space S.

Furthermore, as shown in FIG. 12(c), the polar liquid 16 is moved in the direction indicated by the arrow L1 while transforming toward the upper side portion of FIG. 12(c). As a result, the flow path of the oil 17 can be further secured in the lower side portion of FIG. 12(c) in a peripheral portion of the signal electrode 4, and the oil 17 is thereby moved in the direction indicated by the arrow L2 inside the display space S.

In addition, since the one end portion 4b, the other end portion 4c, and the middle portion 4e are provided in the signal electrode 4 as shown in FIG. 12(a), the polar liquid 16 comes into contact with the signal electrode 4 at all times. Furthermore, since the other end portion 4c of the signal electrode 4 is provided so as not to overlap with the color filter portion 11r, that is, an aperture as shown in FIG. 12(a), a reduction in luminance due to the signal electrode 4 can be prevented, unlike in the second embodiment.

With the above configuration, the same effects and advantages as those in the third embodiment can be exhibited in the present embodiment.

Note that the above-described embodiments are all examples and are not restrictive. The technical scope of the present invention is defined by the claims, and all kinds of modifications within an equal scope to the configurations described in the embodiments can also be included in the technical scope.

For example, the case in which the present invention is applied to an image display device equipped with a display unit has been described above, however, the invention is not limited at all if it is applied to an electrical apparatus provided with a display unit that displays information including characters and images, and can be appropriately used in electrical apparatuses provided with various kinds of display units, for example, mobile information terminals such as electric organizers, or PDAs, display devices accompanied by personal computers, or television sets, electronic paper, and the like.

In addition, since a display element of an electrowetting type that causes a polar liquid to move according to electric field application to the polar liquid can be configured in each of the embodiments, it can cause the polar liquid to move fast with a lower driving voltage than in other display element of an electric field induction type such as an electro-osmotic type, an electro-phoresis type, or a dielectro-phoresis type. In addition, a display element of the electrowetting type is preferable in that display colors are changed according to movements of a polar liquid and it can be easily configured to be a display element to be used in information display showing high luminance and excellent light use efficiency with light emitted from a backlight or external light, different from a liquid crystal display device using a birefringent material such as a liquid crystal layer. Furthermore, since it is not necessary to provide a switching element for each pixel, it is preferable in that a high-performance display element of a matrix drive type having a simple structure can be configured at low cost.

In addition, the case of a transmission type display element having a backlight has been described above, but the present invention is not limited thereto, and can also be applied to a reflection type display element having a light reflection unit such as a diffusion reflecting plate or a transflective type display element using both of such a light reflection unit and a backlight.

In addition, the case in which an aqueous potassium chloride solution is used for the polar liquid has been described above, however, a polar liquid of the present invention is not limited thereto. To be specific, for the polar liquid, a material containing an electrolyte such as zinc chloride, potassium hydroxide, sodium hydroxide, alkali metal hydroxide, zinc oxide, sodium chloride, lithium salt, phosphoric acid, alkali metal carbonate, or ceramics having oxygen ion conductivity can be used. In addition, as a solvent, an organic solvent such as alcohol, acetone, formamide, or ethylene glycol can be used in addition to water. Furthermore, as the polar liquid of the present invention, an ionic liquid (ambient temperature molten salt) containing pyridine-based, alicyclic amine-based, or aliphatic amine-based cations and fluorine-based anions such as fluoride ions or triflate can also be used.

In addition, a conductive liquid having conductivity and a liquid having a high dielectric property having a dielectric constant that is equal to or higher than a predetermined value, or preferably equal to or higher than 15 are contained in the polar liquid of the present invention.

However, as in each of the embodiments described above, using an aqueous solution in which a predetermined electrolyte is dissolved for the polar liquid is preferable in that it has excellent operability and can easily configure a display element that can be simply manufactured.

In addition, the case in which non-polar oil is used has been described above, but the present invention is not limited thereto, and an insulating fluid that will not mixed with the polar liquid is possible, and for example, air may be used instead of oil. In addition, for the oil, silicon oil, aliphatic hydrocarbon, or the like can be used. In addition, in the insulating fluid of the present invention, a fluid having a dielectric constant equal to or lower than a predetermined value, or preferably equal to or lower than 5 is contained.

However, as described in each of the embodiments, using the non-polar oil that does not have compatibility with the polar liquid is more preferable than using air and the polar liquid in that droplets of the polar liquid is easily moved in the non-polar oil, then the polar liquid can be moved fast, and thereby switching display colors fast.

In addition, the case in which the signal electrodes, the reference electrodes, and the scanning electrodes are provided on the lower substrate (second substrate) side has been described above. However, in the present invention, the signal electrodes may be disposed inside the display space so as to come into contact with the polar liquid, the reference electrodes and the scanning electrodes may be provided on either side of the first substrate or the second substrate while being electrically insulated from the polar liquid and each other, and the signal electrodes may be provided on either side of the first substrate or the second substrate so that the flow path of the insulating fluid becomes large inside the display space when the polar liquid is moved in each pixel region, or the signal electrodes, the reference electrodes, and the scanning electrodes may be provided on the upper substrate (first substrate) side.

In addition, the case in which the reference electrodes and the scanning electrodes are respectively disposed on the effective display region side and the non-effective display region side has been described above, but the present invention is not limited thereto, and the reference electrodes and the scanning electrodes may be respectively disposed on the non-effective display region side and the effective display region side.

In addition, the case in which the reference electrodes and the scanning electrodes are provided on the surface of the lower substrate (second substrate) on the display surface side has been described above, but the present invention is not limited thereto, and reference electrodes and scanning electrodes embedded inside the second substrate that is formed of an insulating material can also be used. When configured as above, the second substrate can also be used as a dielectric layer, and thereby installation of a dielectric layer can be omitted. Furthermore, it may be configured that signal electrodes are directly provided on the first and the second substrate that are also used as dielectric layers, and the signal electrodes are disposed inside a display space.

In addition, the case in which a transparent electrode material is used for the reference electrodes and the scanning electrodes has been described above, but the present invention may be configured such that only one electrode of the reference electrode and the scanning electrode which is disposed so as to face the effective display region of a pixel is formed of a transparent electrode material, or the other electrode which does not face the effective display region can be formed of a non-transparent electrode material such as aluminum, silver, chrome, or other metal.

In addition, the case in which the stripe-shaped reference electrodes and scanning electrodes are used has been described above, but the shapes of the reference electrodes and scanning electrodes of the present invention is not limited thereto at all. For example, in a reflection type display element in which use efficiency of light used in information display is further lowered than in a transmission type display element, a shape such as a linear shape, a net shape that hinders occurrence of optical loss may be used.

In addition, the case in which linear wirings are used for the signal electrodes has been described above, but the signal electrodes of the present invention is not limited thereto, and a wiring formed in other shape such as a net-like wiring can also be used.

In addition, the case in which pixels having each of RGB colors are provided on the display surface side using the polar liquid colored in black and the color filter layer has been described above, but the present invention is not limited thereto, and a plurality of pixel regions may be respectively provided on the display surface according to a plurality of colors that can be used in full-color display. Specifically, polar liquids of a plurality of colors which are colored in RGB, CMY of cyan (C), magenta (M), and yellow (Y), RGBYC, or the like can also be used.

In addition, the case in which the color filter layer is formed on the upper substrate (first substrate) on the non-display surface side has been described above, but the present invention is not limited thereto, and the color filter layer can be disposed on the surface of the first substrate on the display surface side or on the lower substrate (second substrate) side. Using the color filter layer in this manner is more preferable than preparing polar liquids of a plurality of colors in that a display element that can be simply manufactured can be easily configured. In addition, it is preferable in that the respective effective display region and non-effective display region are appropriately and assuredly set in the display space by the color filter portions (apertures) and the black matrix portion (light-shielding film) included in the color filter layer.

### INDUSTRIAL APPLICABILITY

The present invention is effective for a display element that can prevent degradation of display quality, an electrical apparatus using the display element even when grayscale display is performed.

### REFERENCE NUMERALS

1 image display device (electrical apparatus)
2 upper substrate (first substrate)
3 lower substrate (second substrate)
4 signal electrode
4b one end portion
4c the other end portion
5 reference electrode
6 scanning electrode
7 signal driver (signal voltage application unit)
8 reference driver (reference voltage application unit)
9 scanning driver (scanning voltage application unit)
10 display element
11 color filter layer
11r, 11g, 11b color filter unit (opening)
11s black matrix portion (light-shielding film)
13 dielectric layer
14 rib
14a first rib member
14b second rib member
16 polar liquid
17 oil (insulating fluid)
S display space
P pixel region
P1 effective display region
P2 non-effective display region
θ predetermined angle

1. A display element configured to include a first substrate provided on a display surface side, a second substrate provided on a non-display surface side of the first substrate so as to form a predetermined display space between the first substrate, an effective display region and a non-effective display region set for the display space, and a polar liquid that is movably sealed on the effective display region side or the non-effective display region side inside the display space, and to be able to change a display color on the display surface side by causing the polar liquid to move, comprising:
a plurality of signal electrodes that is disposed inside the display space and provided along a predetermined arrangement direction so as to come into contact with the polar liquid;
a plurality of reference electrodes that is provided on either side of the first substrate or the second substrate so as to be disposed on one side of the effective display region and the non-effective display region while being electrically insulated from the polar liquid and so as to intersect with the plurality of signal electrodes;
a plurality of scanning electrodes that is provided on either side of the first substrate or the second substrate so as to be disposed on the other side of the effective display region and the non-effective display region while being electrically insulated from the polar liquid and the reference electrodes and so as to intersect with the plurality of signal electrodes;
a plurality of pixel regions that are provided in a unit of intersection portions of the signal electrodes and the scanning electrodes;
a rib that is provided on at least either side of the first substrate or the second substrate so as to hermetically compartment the inside of the display space according to each of the plurality of pixel regions; and
an insulating fluid that is movably sealed inside the display space for each of the pixel regions and does not mix with the polar liquid,
wherein, when the polar liquid is moved inside the display space for each of the pixel regions, the signal electrodes are provided on either side of the first substrate or the second substrate so that the flow path of the insulating fluid inside the display space becomes large.

2. The display element according to claim 1, wherein the signal electrodes are linearly provided along a direction parallel with a movement direction of the polar liquid.

3. The display element according to claim 2,
wherein the rib includes first rib members that are provided along the direction vertical to the movement direction of the polar liquid and second rib members that are provided along the direction parallel with the movement direction of the polar liquid, and
wherein, when the size of separation between the first and the second substrates is set to H, the size of interval between two second rib members compartmenting each of the pixel regions to W, and the distance between one of the second rib member and the center line of each of the signal electrodes in the direction vertical to the movement direction of the polar liquid to x, the signal electrodes are provided so as to satisfy the following inequality (1), which is
H/2<x<W/4 (1).

4. The display element according to claim 1, wherein the signal electrodes are provided so as to form a predetermined angle with a movement direction of the polar liquid.

5. The display element according to claim 1, wherein the signal electrodes are provided so that one end portions and the other end portions thereof are on the one end portion sides and the other end portion sides in respective pixel regions in a direction vertical to a movement direction of the polar liquid.

6. The display element according to claim 1, further comprising:
a signal voltage application unit that is connected to the plurality of signal electrodes and applies a signal voltage within a predetermined voltage range to each of the plurality of signal electrodes according to information displayed on the display surface;
a reference voltage application unit that is connected to the plurality of reference electrodes and applies either voltage of a selection voltage that allows the polar liquid to move inside the display space according to the signal voltage or a non-selection voltage that hinders the polar liquid from moving inside the display space to each of the plurality of reference electrodes; and
a scanning voltage application unit that is connected to the plurality of scanning electrodes and applies either voltage of a selection voltage that allows the polar liquid to move inside the display space according to the signal voltage or a non-selection voltage that hinders the polar liquid to move inside the display space to each of the plurality of scanning electrodes.

7. The display element according to claim 1, wherein the plurality of pixel regions are respectively provided according to a plurality of colors that can perform full-color display on the display surface.

8. The display element according to claim 1, wherein a dielectric layer is laminated on surfaces of the reference electrodes and the scanning electrodes.

9. The display element according to claim 1,
wherein the non-effective display region is set by a light-shielding film provided on either side of the first substrate or the second substrate, and
wherein the effective display region is set by apertures formed on the light-shielding film.

10. An electrical apparatus that includes a display unit that displays information including characters and images thereon,
wherein, for the display unit, the display element according to claim 1 is used.
